(19) United States
(12) Patent Application Publication
(10) Pub. No.: US 2010/0174509 A1
(43) Pub. Date: Jul. 8, 2010

(54) DESIGN PROCESS FOR ELEVATOR ARRANGEMENTS IN NEW AND EXISTING BUILDINGS

(75) Inventors: Arvind U. Raghunathan, Manchester, CT (US); Richard K. Pulling, Avon, CT (US); Mauro J. Atalla, South Glastonbury, CT (US); Theresa M. Christy, West Hartford, CT (US); Vipin Gopal, West Hartford, CT (US); Arthur C. Hsu, South Glastonbury, CT (US)

Correspondence Address: KINNEY AND LANGE PA, 312 S THIRD STREET, MINNEAPOLIS, MN, 55415, US

(73) Assignee: OTIS ELEVATOR COMPANY, Farmington, CT (US)

(21) Appl. No.: 12/601,477

(22) PCT Filed: May 21, 2007
(86) PCT No.: PCT/US07/11993

§ 371 Date: Nov. 23, 2009

(51) Int. Cl. G06F 17/50; G06F 17/10; G06G 7/62

(52) U.S. Cl. 703/1; 703/2; 703/7

(57) ABSTRACT

A method for determining a suitable configuration for an elevator system for a building that includes acquiring building related information and passenger use information. Elevator system performance requirements based on elevator system passenger numbers are selected based on this information followed by selecting a set of elevator system characteristic variables that are desired to be at optimal values which are processed along with the information and performance requirements to provide an optimal solution.

### BACKGROUND OF THE INVENTION

The present invention relates to elevator arrangements for buildings and, more particularly, to methods for designing such arrangements.

Transferring people from one location to another in buildings of any significant size with multiple floors therein is primarily accomplished through the use of elevators provided in such buildings. Doing so on a time efficient basis economically is an undertaking that grows in difficulty and complexity with the size of the building to be fitted with such elevators in terms of the number of floors therein and the numbers of people on those floors at various times during which the building is in use along with their transfer tendencies. In addition, there are typically various constraints such as the number of elevators that can be provided, and where, in a building, especially an existing building being refurbished rather than a new building to be constructed, the size of the elevator cars, the speed and acceleration thereof, etc.

The process for designing elevator arrangements for such buildings has typically been based on elevator arrangement designers with lots of experience in such designs who evaluate the elevator situation in a proposed new or existing building, provide corresponding elevator arrangement design estimates, and then provide their best estimates as to the performance of such arrangements in the building under consideration. These efforts are now often supplemented by using simulation programs on computers to simulate the performance of the proposed elevator arrangement design based on measured, or partly measured and partly estimated, or entirely estimated patterns of elevator use in the building under consideration. Such methods have been difficult and expensive to use, and often lead to less than reliable results. Thus, there is a desire for a better design process for elevator arrangements in proposed new buildings or for elevator arrangements in existing buildings proposed to be refurbished.

### BRIEF SUMMARY OF THE INVENTION

Exemplary embodiments of the invention include a method for determining a suitable configuration for an elevator system for a building. The method includes acquiring building structure characteristics information, desired elevator system capabilities information, and elevator system passengers use characteristics information. The method also includes selecting desired elevator system performance requirements based on elevator system passengers numbers and conveyance times therefor, and selecting a set of elevator system characteristic variables that are desired to be at optimal values. The method also includes processing the building structure characteristics information, the desired elevator system performance requirements, and the set of elevator system characteristic variables to provide at least one of an optimal solution or, if no solution exists, an indication of no solution of an elevator system determined configuration in a time efficient manner.

### BRIEF DESCRIPTION OF THE DRAWINGS

FIG. 1 shows a flow chart embodying a portion of the present invention for determining building elevator arrangements, and

FIG. 2 shows a flow chart embodying a portion of the present invention for determining building elevator arrangements.

### DETAILED DESCRIPTION

There are, of course, many kinds of buildings requiring elevators in them to convey people from one location therein to another including office buildings, retail buildings, hotels, condominium and apartment buildings, hospitals, etc., and mixed use versions combining the purposes of two or more of these kinds of buildings. They differ in many ways including the number of floors therein, the area of those floors, the layouts of those floors, the number of elevators provided therein, the size of the elevator cars, their speed and acceleration, etc.

These building parameters, and often numerous others, combine to require a substantial effort to gather enough information to sufficiently characterize a proposed new building, or an existing building proposed to be refurbished, to allow designing elevator arrangements therefor that provide acceptable, or even optimal, performance in conveying people thereabout. The gathering of such information differs somewhat for proposed existing building refurbishments, where existing structures most often must to a significant degree be retained and so accommodated in the elevator arrangements design, and proposed new buildings with respect to which there is usually greater freedom in arriving at an overall design.

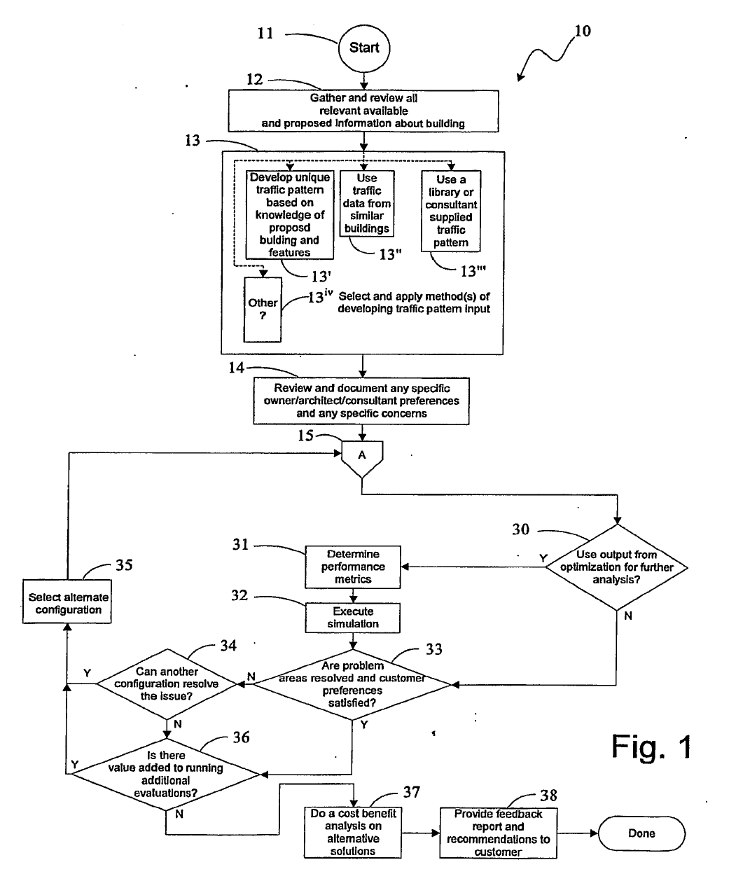

Thus, in a flow chart 10, in FIG. 1, starting in a start balloon, 11, the information gathering process for either a proposed new building, or the refurbishment of an existing building, is undertaken in a performance block, 12. There, the information characterizing such a building must be gathered from those knowledgeably involved with the proposal such as the owner of the building to be constructed, the owner's building consultant or elevator consultant or both, the architect, and the general contractor. There are many possible alternatives for a new building including the use or uses it is to be put, the number of people housed in the building and their likely travel patterns in the building, whether it is to have either a private or public restaurant, whether double deck elevator cars are to, or can, be used, whether there will or can be elevated destination lobbies (“sky lobbies”) for express elevators, the acceptable elevator car speeds and accelerations and ride smoothness, whether destination dispatching is, or can be, used in which the potential passenger selects the floor destination in the hall rather than in the car, etc.

In contrast for a building proposed to be refurbished, the building management personnel and the building maintenance personnel can provide characterizing information as to patterns of elevator use and associated problems encountered with such use, and the details of the existing building structure as part of the information gathering. Additional information as to the nature or character of the refurbishment can be obtained from the owner and the architect along with any consultants employed thereby. In general, there are usually fewer possible alternatives for elevators in existing buildings even in a complete retrofit of the existing elevator system, these possibilities ranging from such a retrofit to the changing of a few parameters in the elevator system operation computer program to change the manner in which corresponding system features operate.

The information gathered for a new building in block 12 can often be represented in a sort of tabular form in a riser diagram formed on a spreadsheet corresponding to either a specified or initially estimated elevator arrangement for the proposed building. The spreadsheet rows correspond in number to the number of elevator served floors in the proposed building so that each spreadsheet row corresponds to a building floor therein, and the columns each correspond to a proposed elevator car group serving a certain fraction of the building floors. Then next to the last column, in each row, data for the floor represented by that row is entered such as the number of people typically present on that floor, the area of the floor, etc. Below each column, data for the elevator car group represented by that column is entered such as the number of cars in the group, the acceleration and speed thereof, the door opening time thereof, etc. Similarly, the data gathered for an existing building in block 12 can usually be represented in a sort of tabular form in a riser diagram formed on a spreadsheet representing the existing building and then again representing a proposed refurbished building.

With this knowledge of a proposed new or a proposed refurbished building in hand, a method must be selected and applied to develop a corresponding characteristic people relocation model for the building, including the building elevator passenger “traffic pattern” and the “traffic lists” based thereon, an effort usually undertaken in conjunction with further information inputs. This effort is made in a further performance block, 13, usually using the knowledge of a person or persons with substantial experience in this activity based on the gathered information concerning the proposed building indicated by a dashed line from the entry to block 14 to a corresponding performance block, 13′, but often supplementing such skill by use of traffic data from buildings known to be similar as indicated by a dashed line to a further performance block, 13″, use of a library of buildings traffic data and use of traffic data developed by consultants as indicated by a dashed line to a further performance block, 13″′, or some combination of these.

Other sources may be available to be used, also as indicated by a dashed line to a further performance block, 13^{iv}, particularly with a building to be refurbished. The existence and use of such a building before a major refurbishment begins allows the acquisition of actual use data for the elevator arrangement presently in that building to thereby develop the traffic patterns currently occurring therein gathered in any suitable manner. These patterns will presumably reflect in large degree the traffic patterns to be encountered in the refurbished building so as to provided guidance in the design of the elevator therefor.

Typically, there are three main traffic patterns of interest, the a) up peak traffic involving mostly passengers arriving in the building lobby desiring to go to various floors in the building such as occurs in the morning start of the day in an office building, b) two way peak traffic involving mostly passengers arriving at the lobby from the building floors and leaving the lobby to go to various floors in the building such as occurs at lunchtime, and c) down peak traffic involving mostly passengers arriving in the building lobby from various floors in the building such as occurs in the late afternoon end of the day in an office building. Traffic patterns are often expressed in histograms (although they need not be as just a traffic list could be compiled) showing passenger traffic versus time in terms of fractions of the building population (or, in buildings with groups of elevators, in terms of fractions of each group population) and five minute intervals. For example, a one hour traffic pattern of up peak traffic may be described as 3% of the building's population arriving during the first five minutes, 5% arriving during the second, five minutes and so on until 12 intervals have been described.

A traffic list is a specific instance of a traffic pattern and is essentially a list of each passenger (by a corresponding assigned number) that uses the elevator system along with corresponding indicators of the nature of that use. Thus, each passenger in the list is essentially characterized by the time that he or she arrives in the hallway of a floor, which of the floors that the arrival occurs upon and so from which floor conveyance service is requested (origin), and to which of the floors conveyance service is requested (destination). Using an algorithm containing a random number generator, a computer program can be written to accept a traffic pattern as input and produce a specific possible passenger list consistent with that pattern. It is understood that any manner of gathering traffic information could be used for this step.

A traffic list can be analyzed to determine the traffic pattern it represents or its characterization of the traffic in various categories such as the amount of up traffic or down traffic, or the amount of two way traffic, and the like. Such analyses, as indicated above, aid in the decisions for making a proper choice of an elevator arrangement for a building. Further required for such decisions are any constraints within which those decisions must be made. Thus, in a further performance box, 14, reviews are made of any preferences that the owner, architect or consultant have that are to be satisfied, and which can vary widely, such as solutions for anticipated special problems, use of only even numbers of elevators, and so on, and of any anticipated or known special problems and any required solutions therefor are determined.

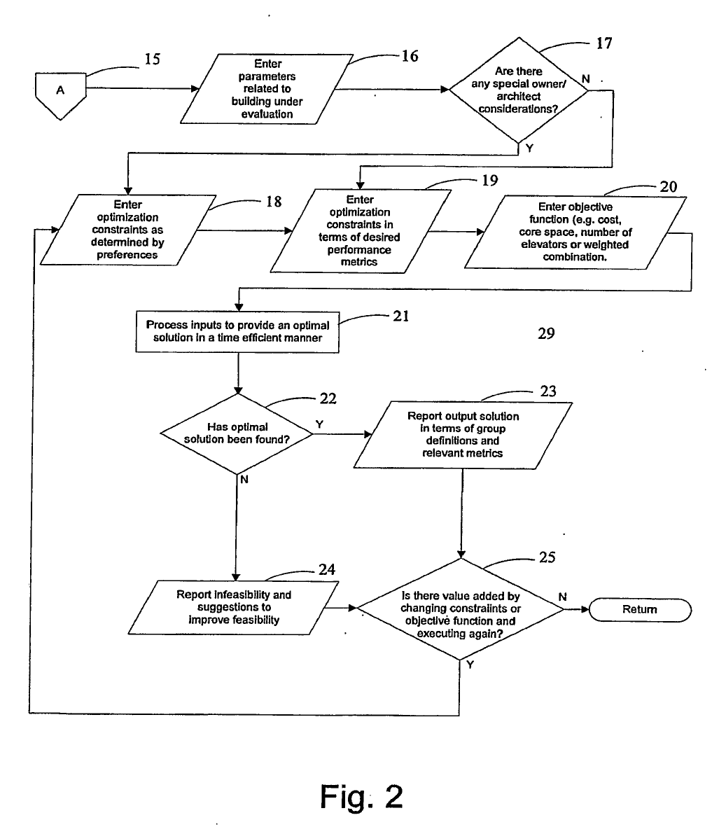

Based on the information accumulated in the foregoing efforts, a first configuration for the new or existing building elevator system arrangement is chosen using a computer based optimization procedure that requires processing of that information. This processing is depicted in FIG. 2 reached through in an off-page reference symbol, 15, containing the designation A which is also contained in the corresponding off-page reference symbol 15 in the flow chart of FIG. 2 where this processing begins.

Turning to this processing method, first, the parameters determined above related to the building elevator system being considered are provided, 16, including such parameters as traffic lists, elevator car speeds and accelerations, number of floors in the building, number of people to be housed in the building, etc. A check is then done in a decision diamond, 17, as to whether there were any specific preferences or concerns determined in block 14. If so, the corresponding optimization constraints are provided, 18, prior to providing the further optimization constraints due to the desired performance metrics, 19.

If no specific preferences or concerns are identified in decision diamond 17, the optimization constraints due to the desired elevator system performance metrics are provided 19. These performance metrics include a) round trip time for an elevator car to leave lobby, complete service stops and return based on the probable number of stops on the way up or on the way down or both, b) interval or the time between elevator cars in a group returning to the lobby found by dividing the round trip time by the number of cars in the group, c) handling capacity as the number of passengers delivered in five minute durations per group of elevator cars as a fraction of the number of potential passengers in the appropriate elevator group, d) probable number of elevator car stops up and down, e) high call reversal as the average highest floor reached by an elevator car in a group after departure from the lobby, average wait time, average service time, and selected others for the various conditions encountered.

Having provided the constraints, an objective function must be determined and provided specifying the variables for which the values are to be optimized subject to those constraints, 20. Such variables include the number of elevators, the building space devoted to those elevators, the purchase and operating costs of those elevators, the energy consumed in operating those elevators, the maintenance cost of those elevators, etc., and those selected are typically represented in a linear combination thereof provided as weighted averages. These constraints and this objective function are together processed through an optimization process, 21.

The process occurs in a time efficient manner, which is typically less than 30 minutes. In order for the process to occur in a time efficient manner, the process is typically chosen from one of the following processes including, but not limited to, Nonlinear Programming, Mixed Integer Linear Programming, Mixed Integer Nonlinear Programming, Dynamic Programming or Constraining Programming. In such processes, a computer searches over the space of elevator system configurations to locate configurations solution values for the variables and can be caused to do so using only a subset of the constraint equations and modified objective functions in addition to using all of the constraints and the originally formulated objective function.

This optimization process is monitored in a following decision diamond, 22, to determine if the process is converging suitably to one or more solutions. If so and those solutions have been found, output data from the optimization process is provided, 23, for those solutions in terms of an elevator system configuration solution providing groupings of elevator cars with the number thereof in each group and the groups of building floors each car group is to serve along with the resulting performance metrics. In the instance of more than one set of solution values, a listing of those solutions is provided ranked on a selected basis. If not, a report is provided, 24, to report that determination and to provide an indication of the cause and an indication or indications of changes in the optimization constraints determined by preferences or desired performance metrics that would increase the likelihood of finding a feasible solution.

Such causal indications are then evaluated in a final decision diamond, 25, in FIG. 2 to judge if there is sufficient likelihood of reaching some optimal solution if the constraints or the objective function or both are changed in some way. If so, such changes are entered into the computer 18 the process is repeated. However, even if an optimal solution was reached as found in decision diamond and reported 29, a judgment about the value of changing the constraints or the objective function or both is made. If of sufficient value, such changes are also entered into the computer 23 and the process is repeated. Assuming that an optimal solution is found following such changes, a table of configuration alternatives results is indexed by the range of such changes. Completion of these optimization activities results in returning to the design process in FIG. 1 at off-page reference symbol 15 containing the designation A.

There, a judgment is made in a decision diamond, 30, as whether to just accept the optimization result configuration as the primary design configuration without simulating the performance of that configuration, or whether to provide the optimization elevator system configuration performance metrics in a performance block, 31, for the simulation to provide a basis for estimating the performance of the configuration chosen on average. Sometimes these estimates are taken as sufficient configuration performance indicators, and they are fairly easy values to determine, but the further finding of performance metrics through simulating the performance of an elevator system configuration based on traffic lists is believed to provide better indications of the configuration performance. Thus, if simulation is to be undertaken, this step next follows in a performance block, 32, in which effort a computer program is used that is intended to mimic the performance of the elevator system configuration under a specified set of conditions.

In performing such elevator system configuration simulations, very specific inputs, including number of elevators, elevator velocity, elevator acceleration, elevator size, number of passengers that can fit into an elevator, the number of floors in a building, the type of dispatching, etc., must be provided to the simulation program so that the results from the simulation closely approximate what would happen under those same conditions in a real building. One of the important inputs to a simulation program is a traffic list. In order to mimic performance the computer program must have as input every person that arrives, when and where they arrive and where they want to go. This is information provided in a traffic list.

The metrics produced by simulation of elevator system configurations are many, but the most important include waiting time and service time. Waiting time is how long a passenger waits in the hallway before an elevator arrives to service him or her and service time is how long elapses between his or her arrival in the hallway and his or her arrival at the destination floor, that is, the waiting time plus the time in the elevator car.

Once the various elevator system performance metrics are obtained by estimation, or by simulation, or by both, or by optimization, or by all of the foregoing, the configuration under consideration is reviewed in a decision diamond, 33, to determine if the problems present in providing a new elevator system or in refurbishing the elevators system in an existing building have been solved and the associated preferences satisfied. If not, the cause is reviewed in a further decision diamond, 34, to determine if it can be overcome through choosing an alternative configuration or choosing an alternative input parameter. If so, a new configuration or different input parameters are selected in a performance block, 35, and that configuration is subjected to the same evaluation as the preceding one beginning in off-page symbol 15.

If the problems have been determined to have been solved and the preferences satisfied in decision diamond 33, or if resort to a different configuration to solve the problems and satisfy the preferences in decision diamond 34 appears impossible, there still may be some value in considering further alternative configurations in another decision diamond, 36. Thus, alternative configurations might be evaluated as being possible to implement at a lower cost, or other effects of choosing alternative configurations may wish to be evaluated. If so, as before, a new configuration is selected in performance block 35, and that configuration is subjected to the same evaluation as the preceding one beginning in off-page symbol 15.

If the benefit of evaluating further elevator system configurations is found to have been exhausted in decision diamond 36, a cost benefit analysis for alternative configurations evaluated is undertaken in a performance block, 37. Then the results of the foregoing design process are gathered in a further performance block, 38, and a corresponding report is provided to the existing or future building owner as the customer, after which the process is complete.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

Although the present invention has been described with reference to preferred embodiments, workers skilled in the art will recognize that changes may be made in form and detail without departing from the spirit and scope of the invention.

1. A method for determining a suitable configuration for an elevator system for a building, the method comprising:
acquiring building structure characteristics information, desired elevator system capabilities information and elevator system passengers use characteristics information,
selecting desired elevator system performance requirements based on elevator system passengers numbers and conveyance times therefor,
ascertaining those elevator system configurations compatible with the building structure characteristics information, desired elevator system capabilities information and elevator system passengers use characteristics information, and the desired elevator system performance requirements,
selecting a set of elevator system characteristic variables that are desired to be at optimal values, and
processing the building structure characteristics information, desired elevator system capabilities information and elevator system passengers use characteristics information, the desired elevator system performance requirements, and the set of elevator system characteristic variables through searching over at least a portion of the compatible elevators system configurations to provide either an optimal solution elevator system determined configuration or an indication of no solution in finding an elevator system configuration.

2. The method of claim 1 wherein the elevator system passengers use characteristics information is contained in histograms showing passenger traffic versus time in terms of fractions of a corresponding elevator passenger population.

3. The method of claim 2 wherein a traffic list is formed in providing the elevator system passengers use characteristics information based on a histogram and characterizing each passenger on the list by times that passengers arrives in the hallway of a floor, which building floors such arrivals occur upon and so from which floor conveyance service is requested, and to which of the floors conveyance service is requested.

4. The method of claim 1 further comprising determining performance of the elevator system determined configuration by determining selected performance metrics achieved by the elevator system determined configuration.

5. The method of claim 1 further comprising determining performance of the elevator system determined configuration by simulating performance of the elevator system determined configuration to obtain simulation results.

6. The method of claim 5 wherein after the simulating of performance, a determination is made, based at least on the simulation results, an alternate elevator system configuration is selected through changes in at least some of the desired capabilities or required performances followed by repeating the processing.

7. The method of claim 5 further comprising determining performance of the elevator system determined configuration by using the simulation results to determine selected performance metrics achieved by the elevator system determined configuration.

8. The method of claim 1 wherein more than one optimal solution elevator system determined configuration is determined and they are ranked relative to one another on a selected basis.

9. The method of claim 8 wherein, during the processing to determine an optimal solution, a determination is made whether changes in preferences or desired performance metrics would increase the likelihood of finding a solution.

10. The method of claim 1 wherein, during the processing to determine an optimal solution, a determination is made whether such an optimal solution can be found.

11. A method for evaluating a configuration for an alternative elevator system for an existing building having a current elevator system operated at least in part under control of an elevator system control computer program, the method comprising:
acquiring building structure characteristics information and desired alternative elevator system capabilities information,
acquiring current elevator system passengers use characteristics information through the elevator system control computer program, and
simulating performance of the alternative elevator system based on the building structure characteristics information, the desired alternative elevator system capabilities information, and the current elevator system passengers use characteristics information to obtain simulation results.

12. The method of claim 11 further comprising determining the alternative elevator system performance by using the simulation results to determine the performance metrics achieved by the alternative elevator system configuration.
